(19) United States
(12) Patent Application Publication
(10) Pub. No.: US 2026/0368954 A1
(43) Pub. Date: Nov. 19, 2026

(54) DIFFUSION MODEL FOR GENERATING SPATIALLY CONSISTENT MATERIAL MAPS

(71) Applicant: Adobe Inc., San Jose, CA (US)

(72) Inventors: Yiwei HU, Lafayette, CA (US); Milos HASAN, Lafayette, CA (US)

(21) Appl. No.: 19/206,782

(22) Filed: May 13, 2025

(51) Int. Cl. G06T 11/10; G06T 3/40

(52) U.S. Cl. CPC G06T 11/10; G06T 3/40

(57) ABSTRACT

In some aspects, a processing device may obtain a diffusion model configured to generate a group of images, wherein an attention mechanism of the diffusion model applies cross-attention such that the group of images has shared spatial features. The processing device may train the diffusion model using a material dataset. The processing device may use the trained diffusion model to generate a group of material maps with spatially aligned features from an input prompt that describes a material. In some aspects, each material map in the group of material maps is an image that depicts a respective optical property associated with the material.

### BACKGROUND

Diffusion models are generative machine learning (or artificial intelligence) models that have demonstrated significant success in various visual applications, such as image synthesis and video generation, and in other areas such as audio generation, text generation, and bioinformatics. In particular, diffusion models can be trained to iteratively transform an initial noise distribution (e.g., Gaussian noise) into a complex real-world data distribution, such as images, videos, or associated encodings, by first adding noise to existing data in a forward diffusion process, and then learning to reverse the forward diffusion process and effectively denoise the data to generate realistic outputs. In the forward diffusion process, which is often modeled as a Markov chain, an original data distribution or sample (e.g., an image or video sample) is progressively transformed into a noise distribution by iteratively adding Gaussian noise to the data sample. The reverse diffusion process, which is often modeled as a reverse Markov chain, starts with a noise distribution (e.g., pure Gaussian noise), and noise is iteratively removed from the noise distribution to reconstruct the original data. Accordingly, after training, the diffusion model can generate new samples by starting with noise and iteratively applying the reverse diffusion process to generate high-quality, diverse, and realistic data samples.

### SUMMARY

According to some aspects described herein, a diffusion model includes an attention mechanism (e.g., an architecture with one or more attention layers) designed to apply cross-attention when generating a group of images that each depict a respective optical property of a digital material. Given an input prompt (e.g., a text prompt or an image prompt) related to a digital material, the attention mechanism applies cross-attention to generate a set of spatially consistent images that depict different optical properties of the digital material. For example, in some aspects, the diffusion model is trained using one or more datasets to generate images from input prompts that may include text, images, or other suitable guidance. In addition, the attention mechanism of the diffusion model is designed to apply cross-attention when generating a group of images, such that each pixel in a group of images that is synthesized from a given input prompt is generated with attention to every other pixel in the group of images. In this way, the diffusion model shapes feature maps to ensure that attention spans all images within the group when attention is applied, such that the synthesized images in a batch are spatially consistent (e.g., different images in the batch have similar shapes that are located in similar places). Further, the diffusion model is trained (e.g., fine-tuned) using a material dataset that digitally represents material maps for various materials (e.g., fabrics, metals, plants, stones, concrete, and other materials in various colors, textures, patterns, or the like). Accordingly, after training the diffusion model using the material dataset, the diffusion model may be used for text-to-material or image-to-material generation, where an input prompt describing or depicting a material is mapped to a group of spatially consistent images that each depict a respective optical property associated with the material (e.g., a base color, a normal map, a roughness, or the like).

In some aspects, a method may include obtaining a diffusion model configured to generate a group of images, wherein an attention mechanism of the diffusion model applies cross-attention such that the group of images has shared spatial features. The method may include training the diffusion model using a material dataset. The method may include using the trained diffusion model to generate a group of material maps with spatially aligned features from an input prompt that describes a material, wherein each material map in the group of material maps is an image that depicts a respective optical property associated with the material.

In some aspects, a system may include a memory component and a processing device coupled to the memory component. The processing device may be configured to obtain a model configured to generate a group of images with shared spatial features. The processing device may be configured to train the model using a material dataset. The processing device may be configured to use the trained model to generate a group of material maps with spatially aligned features from an input prompt that describes a material, wherein each material map in the group of material maps is an image that depicts a respective optical property associated with the material.

In some aspects, a method may include receiving a prompt that describes a material. The method may include inputting the prompt that describes the material to a diffusion model. The method may include obtaining an output from the diffusion model, wherein the output comprises a group of material maps with spatially aligned features, wherein each material map in the group of material maps depicts a respective optical property associated with the material.

Aspects described herein generally include a method, a system, a device, a non-transitory computer-readable medium, and/or an apparatus, as substantially described herein with reference to and as illustrated by the drawings and specification.

The foregoing has broadly outlined the features and technical advantages of examples described herein such that that the detailed description that follows may be better understood. Additional features and advantages will be described hereinafter. The conception and specific examples described herein may be readily utilized as a basis to modify or design other aspects for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

FIG. 1 illustrates examples associated with generating images using a diffusion model, according to some aspects of the present disclosure.

FIG. 2 illustrates an example guided diffusion model, according to some aspects of the present disclosure.

FIG. 3 illustrates an example U-Net, according to some aspects of the present disclosure.

FIG. 4 illustrates an example method for conditional media generation, according to some aspects of the present disclosure.

FIG. 5 illustrates an example diffusion process, according to some aspects of the present disclosure.

FIG. 6 is a flow diagram illustrating an example procedure for training a machine learning model, according to some aspects of the present disclosure.

FIG. 7 illustrates an example method for training a diffusion model, according to some aspects of the present disclosure.

FIG. 8 illustrates an example associated with training a diffusion model to generate spatially consistent material maps, according to some aspects of the present disclosure.

FIG. 9 illustrates an example associated with using a diffusion model to generate spatially consistent material maps, according to some aspects of the present disclosure.

FIG. 10 illustrates an example user interface associated with using a diffusion model to generate spatially consistent material maps, according to some aspects of the present disclosure.

FIG. 11 illustrates an example environment associated with a diffusion model for generating spatially consistent material maps, according to some aspects of the present disclosure.

FIG. 12 illustrates an example process associated with training and using a diffusion model to generate spatially consistent material maps, according to some aspects of the present disclosure.

FIG. 13 illustrates an example process associated with using a diffusion model to generate spatially consistent material maps, according to some aspects of the present disclosure.

FIG. 14 illustrates an example device associated with a diffusion model for generating spatially consistent material maps, according to some aspects of the present disclosure.

FIG. 15 illustrates an example material mapping apparatus, according to some aspects of the present disclosure.

### DETAILED DESCRIPTION

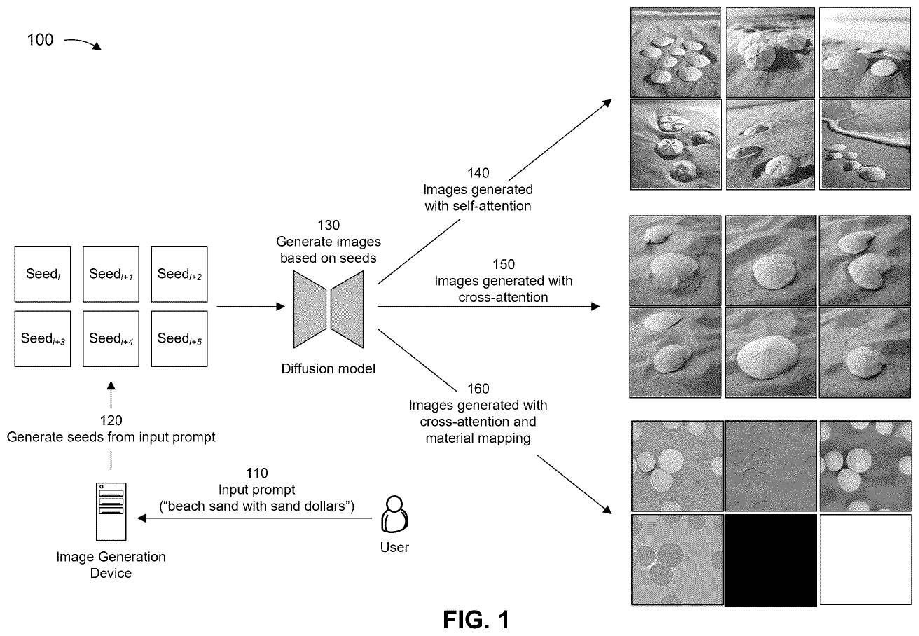

FIG. 1 illustrates examples 100 associated with generating images using a diffusion model, according to some aspects of the present disclosure. As shown in FIG. 1, a user interacts with an image generation device that executes an application or supports an application that can use a diffusion model to generate images based on an input prompt, such as a text prompt, an image prompt, or other suitable user input that provides guidance for generating images. In some aspects, the image generation device may be a user device that executes the application, a server that executes the application and provides a user interface for interacting with the user via a user device, or a server that performs processing tasks to provide computational resources to support the application executing on the user device, among other examples.

As described herein, digital materials that are represented as texture maps are often used in physically-based rendering (PBR) workflows. For example, a digital material is typically defined according to a set of two-dimensional (2D) images, where each pixel in an image encodes an optical property or attribute such as a base color, a normal map, a height (or depth), a roughness, a metallic finish, and/or an opacity. Accordingly, in some cases, digital artists can use text-to-material or image-to-material models to generate texture maps or material maps and efficiently prototype designs (e.g., by allowing the artist to design materials, capture and create three-dimensional (3D) assets or objects, and/or render scenes that incorporate digital materials). However, one challenge in text-to-material generation (where material maps are generated based on a text prompt) and image-to-material generation (where material maps are generated based on an input image) is ensuring that the model outputs multiple images that each capture a distinct optical property of the same material with spatial consistency across all channels (e.g., across all images in the set of images). For example, fine-tuning a model used to generate images (e.g., a text-to-image diffusion model) is difficult because such models are typically designed to generate only a single red-green-blue (RGB) image at a time. Furthermore, techniques to train a diffusion model from scratch tend to produce low-quality results because the resulting models fail to effectively leverage knowledge embedded in pretrained text-to-image foundation models. In addition, techniques that use a two-stage pipeline (e.g., generating images and then converting the images to material maps) cannot generate various material channels simultaneously or ensure that different material channels are spatially aligned while preserving feature consistency.

Accordingly, in some aspects described herein, a diffusion model may include an attention mechanism designed to apply cross-attention to generate a set of spatially consistent multi-channel material maps. For example, each material map is an image that depicts a respective optical property or attribute associated with a digital material based on the same input prompt (e.g., analogous to an image including RGB channels or RGB and alpha channels, a material map may be associated with channels such as roughness, opacity, normal, or the like). For example, in some aspects, a processing device obtains a foundation diffusion model, also known as a large X model (LxM), that has been trained on vast datasets to generate images, video, or other media items from an input prompt that may include text, an image, or other suitable guidance. In some aspects, the attention mechanism of the diffusion model applies cross-attention when generating a group of images, where applying cross-attention causes the diffusion model to shape feature maps in a way that groups pixels of all images in a batch before attention is applied. As a result, the synthesized images in a batch are spatially consistent (e.g., different images in the batch have similar shapes that are located in similar places). The processing device trains (e.g., fine-tunes) the diffusion model using a material dataset that digitally represents material maps for various materials (e.g., fabrics, metals, plants, stones, concrete, and other materials in various colors, textures, patterns, or the like). Accordingly, after the fine-tuning using the material dataset, the diffusion model may be used for text-to-material or image-to-material generation, where an input prompt describing or depicting a material is mapped to a group of spatially consistent images that each depict a respective optical property associated with the material.

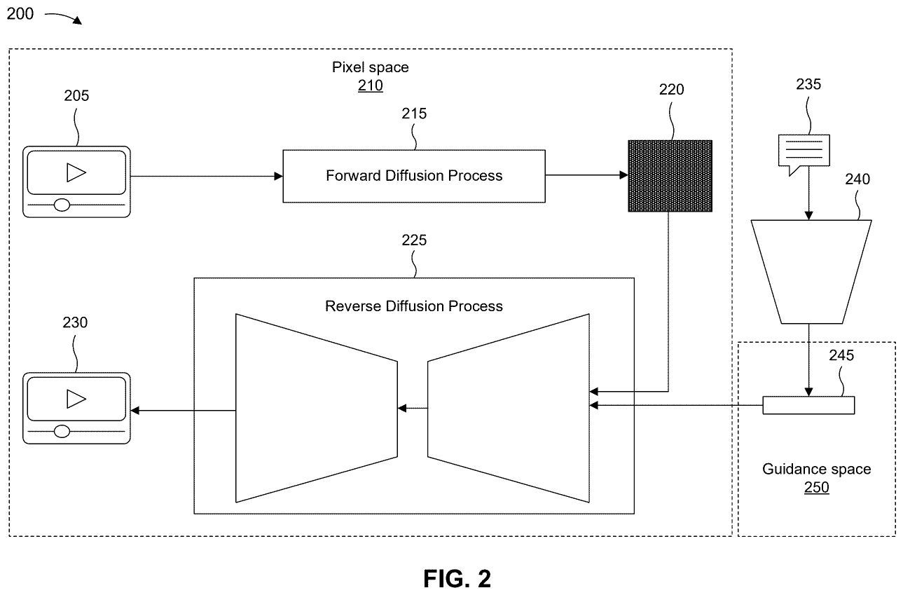

For example, as shown by reference number 110 in FIG. 1, a user may provide an input prompt to an image generation device, where the input prompt provides guidance for a set of images to be generated by the image generation device. In the example illustrated in FIG. 1, the input prompt is a text prompt that includes the text “beach sand with sand dollars” to indicate that the image generation device is to generate a set of images depicting beach sand with sand dollars. Additionally, or alternatively, in some cases, the input prompt may include other suitable guidance, such as an image. As further shown by reference number 120 in FIG. 1, the image generation device generates various seeds from the input prompt, where the seeds are used to control randomness in various processes associated with the image generation. For example, each seed may be used to randomly initialize stochastic gradient descent or other optimization algorithms that rely on randomness to ensure that random choices are consistent across different runs, to introduce randomness in creating different data samples or to select random features, and/or to randomize hyperparameter tuning techniques, among other examples. For example, to generate a batch or group of six images based on the input prompt, the image generation generates six seeds that are used to randomize the image generation process. As shown by reference number 130, the seeds are then input to a diffusion model to generate a batch or group of images based on the input prompt. For example, the diffusion model may generate the batch or group of images using one or more techniques described herein with respect to FIGS. 2-7.

To illustrate some aspects related to generating spatially consistent material images or material maps with cross-attention, reference number 140 corresponds to a first use case where the attention mechanism of the diffusion model is configured to apply self-attention when generating a group of images. For example, in a diffusion transformer architecture, an attention mechanism generally determines the relative importance associated with each object in a sequence relative to other objects in the sequence. In a self-attention configuration, for each element in an input prompt, the model computes a query vector that represents what the model is currently focused on, a key vector that represents features of other elements in the input prompt that may be relevant, and a value vector that contains actual information to be used or passed to a next layer. Accordingly, the query, key, and value vectors can be used to compute weights for each element in the input prompt, which are used to derive vectors that capture relationships between elements in the input prompt and thereby generate images with attention to different elements in the input prompt. However, the self-attention is applied independently to each image in the batch, without awareness or attention to other images in the batch, such that the images in the group are generated without shared spatial features. For example, as shown by reference number 140, the diffusion model uses self-attention to generate a first image associated with a first seed, a second image associated with a second seed, a third image associated with a third seed, and so on. As a result, the images in the batch lack shared spatial features other than the presence of sand dollars on a beach (e.g., number of sand dollars, the orientation of the sand dollars, the backgrounds, and various other details vary).

Accordingly, as shown by reference number 150, and in accordance with some aspects described herein, the attention mechanism associated with the diffusion model may be designed to apply cross-attention, which increases spatial consistency or spatial alignment across the images in the batch. For example, in some aspects, the attention mechanism associated with the diffusion model may shape feature maps to group all of the pixels in a batch of images before attention is applied, ensuring that attention spans all images within the batch. For example, a spatial transformer associated with the diffusion model may apply cross-attention using query, key, and value tensors represented as:

q,k,v∈ [symbol] ^{b×n×h×d} (1)

where b is a batch size, n is a number of spatial pixels in each image, h is a number of attention heads, and d represents feature dimensions. In some aspects, the query, key, and value tensors are shaped to group the various images in a batch together and then perform attention operations. For example, the query, key, and value tensors are shaped such that each pixel in the batch of images is generated with attention to every other pixel in the batch (e.g., the seeds are used to simultaneously generate the various images, with attention applied across the entire set of images). For example, given the parameters b, n, h, and d, and a parameter m that represents the number of images in a batch, the query, key, value tensors are shaped to group the n and m parameters (e.g., the number of spatial pixels and the number of images in the batch), such that the various images are generated simultaneously with attention in each pixel in the batch, ensuring spatial consistency across the various images.

As a result, the knowledge embedded in the pre-trained diffusion model results in high-quality synthesized images, and the images that the diffusion model generates when applying cross-attention are spatially consistent across the entire group. For example, FIG. 1 illustrates a set of images where the sand dollars in each image are about the same size and are spatially aligned. Accordingly, the cross-attention design of the attention mechanism promotes spatial consistency across the images in a batch, such that the diffusion model can then be fine-tuned (e.g., trained) using a material dataset to produce a high-quality text-to-material or image-to-material diffusion model. For example, in some aspects, the material dataset may include a large library of digital assets that represent various materials and material properties. For example, the material dataset may include digital representations for materials such as different types of wood, metal, fabric, plastic, glass, concrete, bricks, paper, and leather, among other examples, and for other material properties such as patterns, corrosion, cracks, paint, rust, scratches, metal finishes, or the like. Accordingly, as shown by reference number 160, utilizing the attention mechanism of the diffusion model that applies cross-attention and training the diffusion model using the material dataset results in the diffusion model having capabilities to generate a group of spatially aligned material maps (e.g., images) that collectively represent a single material and individually represent a single optical property or attribute of the material from the seeds within the same channel group (e.g., seeds associated with the same input prompt). For example, in FIG. 1, the input prompt “beach sand with sand dollars” results in a group of material maps or images with nearly identical spatial features (e.g., the same number of sand dollars, which have the same size, orientation, and placement across the entire batch). In addition, each material map depicts a particular property, corresponding to a channel of the material maps, such as base color, normal map, height, roughness, metallic, or opacity.

In this way, some aspects described herein generate high-quality groups of images with spatially aligned features to collectively represent a single digital material and individually represent specific optical properties of the digital material. Furthermore, some aspects described herein generate the groups of images, or material maps, using a diffusion model that incorporates knowledge embedded in text-to-image foundation models that have been trained to generate images using vast datasets and material datasets that model various digital materials, textures, and other visual and tactile details. In addition, the diffusion model is conditioned on text and images using pre-trained embedding networks in the foundation model and the material dataset, which allows the diffusion model to function as a text-to-material or image-to-material model.

As indicated above, FIG. 1 is provided as an example. Other examples may differ from what is described with regard to FIG. 1.

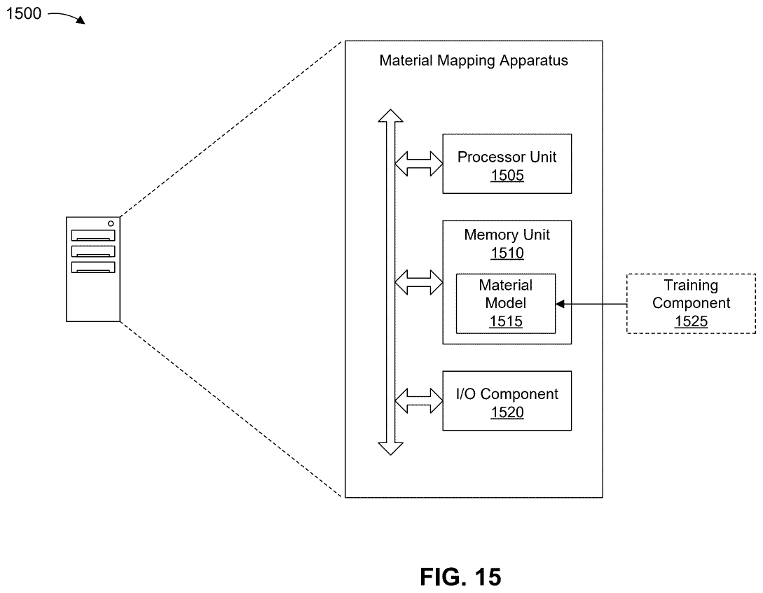

FIG. 2 illustrates an example guided diffusion model 200, according to some aspects of the present disclosure. In some examples, the guided diffusion model 200 describes the operation and architecture of the material model 1515 described with reference to FIG. 15. In some examples, the guided diffusion model 200 depicted in FIG. 2 is an example of, or includes or implements aspects of, a media generation model (e.g., a text-to-material model or image-to-material model that supports a cross-attention configuration) as described herein.

Diffusion models are a class of generative neural networks that can be trained to generate new data with features similar to features found in training data. In particular, diffusion models can be used to generate media items such as images, videos, audio files, 3D models, or other digital media items. Diffusion models can be used for various media processing tasks including image super-resolution, generating media items with perceptual metrics, conditional generation (e.g., generation based on an input prompt that provides text-based guidance or image-based guidance), image inpainting, and/or media manipulation.

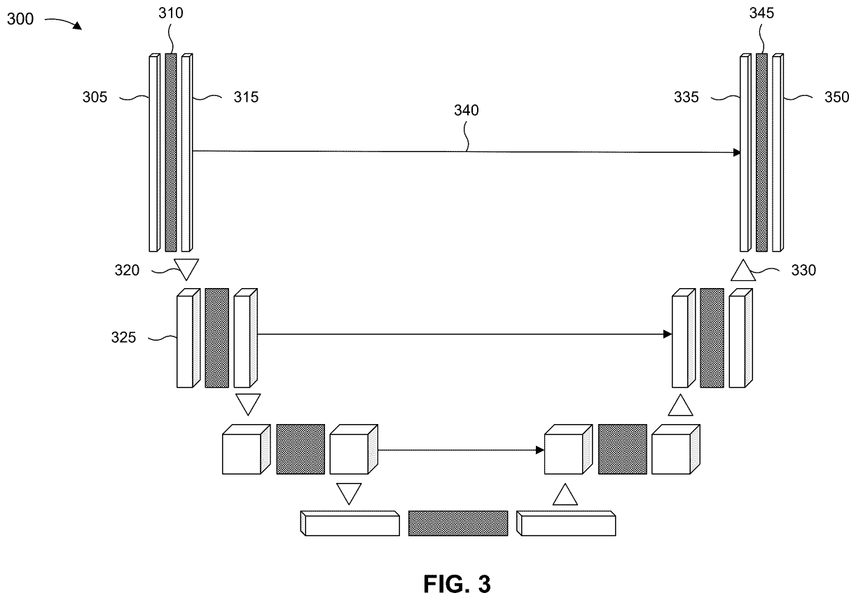

Diffusion models work by iteratively adding noise to a data sample during a forward diffusion process and then learning to recover the data sample by denoising the data sample during a reverse diffusion process. For example, during training, the guided diffusion model 200 may take an original media item 205 in a pixel space 210 as an input and apply a forward diffusion process 215 to gradually add noise to the original media item 205 to obtain a noisy media item 220 at various noise levels. Next, a reverse diffusion process 225 (e.g., a U-Net, as described in further detail with reference to FIG. 3) gradually removes the noise from the noisy media item 220 at the various noise levels to obtain an output media item 230. In some cases, an output media item 230 is created from each of the various noise levels. The output media item 230 can be compared to the original media item 205 to train the reverse diffusion process 225.

In some examples, the reverse diffusion process 225 can be guided based on an input prompt 235, a text prompt, an image prompt, a layout, a segmentation map, or another suitable guidance prompt. The input prompt 235 can be encoded using an encoder 240 (e.g., a text encoder, a multimodal encoder, or another suitable encoder) to obtain guidance features 245 in a guidance space 250. The guidance features 245 can be combined with the noisy media item 220 at one or more layers of the reverse diffusion process 225 to ensure that the output media item 230 includes content described by the input prompt 235. For example, the guidance features 245 can be combined with the noisy features using a cross-attention block within the reverse diffusion process 225.

In some examples, methods to operate diffusion models, such as the guided diffusion model 200, include a denoising diffusion probabilistic model (DDPM) and a denoising diffusion implicit model (DDIM). In DDPM, the generative process includes reversing a stochastic Markov diffusion process. In DDIM, the generative process uses a deterministic process such that the same input results in the same output. In some cases, DDIM can reduce the number of timesteps during media generation. Diffusion models may also be characterized by whether the noise is added to the media item (e.g., media item 205), or to media features (e.g., guidance features 245) generated by an encoder (e.g., via latent diffusion). In a pixel diffusion model, noise is added and removed in a pixel space, such as pixel space 210. In a latent diffusion model, the noise is added (and removed) in a latent space of media features rather than in a pixel space. Accordingly, a latent diffusion model generates media features using reverse diffusion, and the media features can be decoded to obtain a synthetic media item.

As indicated above, FIG. 2 is provided as an example. Other examples may differ from what is described with regard to FIG. 2.

FIG. 3 illustrates an example U-Net 300, according to some aspects of the present disclosure. In some examples, the U-Net 300 is an example component that performs the reverse diffusion process 225 of the guided diffusion model 200 described with reference to FIG. 2 and includes architectural elements of the material model 1515 described with reference to FIG. 15. The U-Net 300 depicted in FIG. 3 is an example of, or includes or implements aspects of, the architecture used within the reverse diffusion process 225 described with reference to FIG. 2.

In some examples, diffusion models are based on a neural network architecture known as a U-Net. The U-Net 300 takes input features 305 having an initial resolution and an initial number of channels and processes the input features 305 using an initial neural network layer 310 (e.g., a convolutional network layer) to produce intermediate features 315. The intermediate features 315 are then down-sampled using a down-sampling layer 320 to generate down-sampled features 325 that have a resolution that is lower than an initial resolution of the intermediate features 315 and a number of channels that is greater than an initial number of channels of the intermediate features 315.

In some examples, the process of generating intermediate features and then generating down-sampled features is repeated multiple times, and then the process is reversed. For example, the down-sampled features 325 are up-sampled using an up-sampling layer 330 to obtain up-sampled features 335. The up-sampled features 335 can be combined with intermediate features 315 having the same resolution and the same number of channels via a skip connection 340. The inputs (e.g., the up-sampled features 335, alone or combined with the intermediate features 315 with the same resolution and number of channels) are processed using a final neural network layer 345 to produce output features 350. In some examples, the output features 350 have the same resolution as the initial resolution of the input features 305 and the same number of channels as the initial number of channels of the input features 305.

In some cases, the U-Net 300 takes additional input features to produce conditionally generated output. For example, the additional input features may include a vector representation of an input prompt. The additional input features can be combined with the intermediate features 315 within the neural network at one or more layers. For example, a cross-attention module can be used to combine the additional input features and the intermediate features 315.

As indicated above, FIG. 3 is provided as an example. Other examples may differ from what is described with regard to FIG. 3.

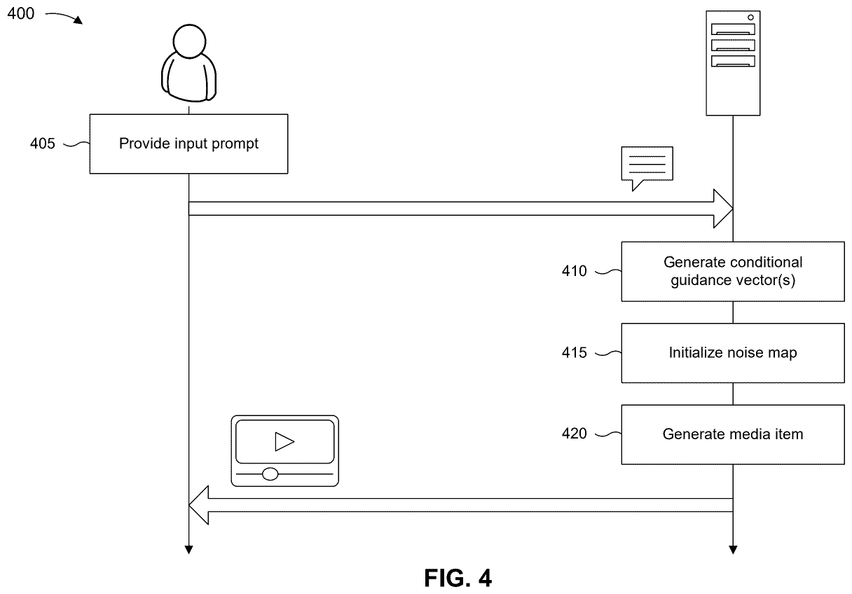

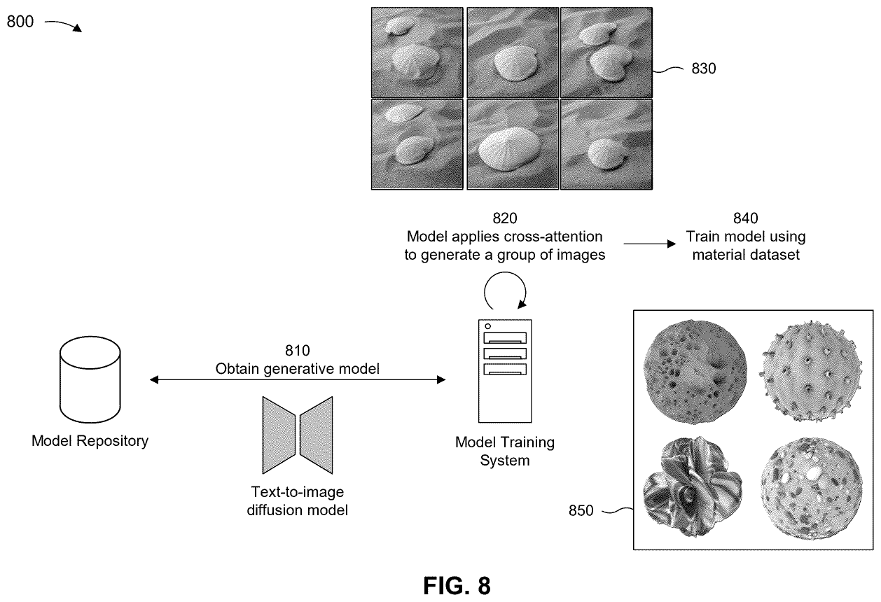

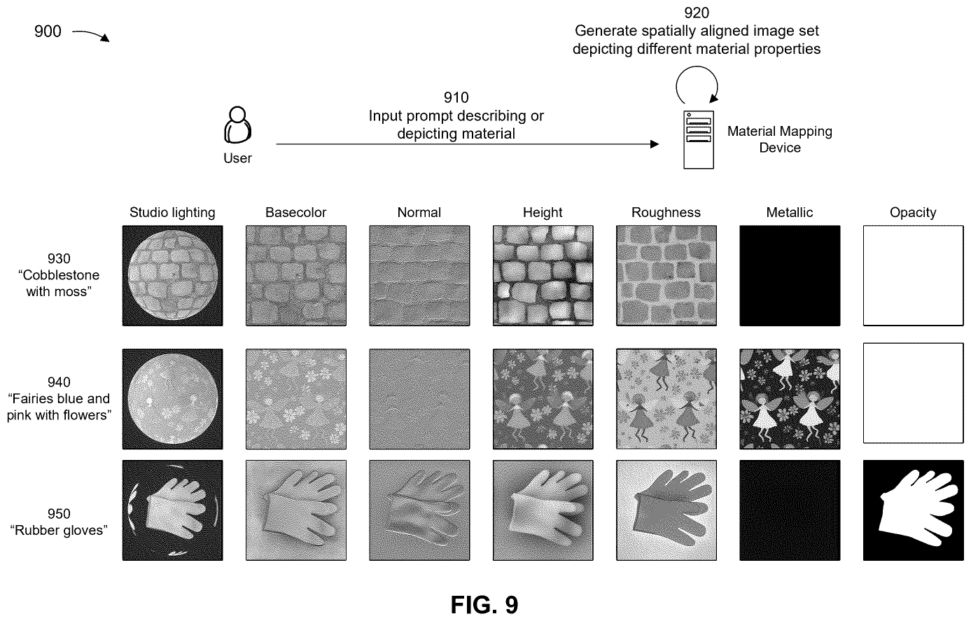

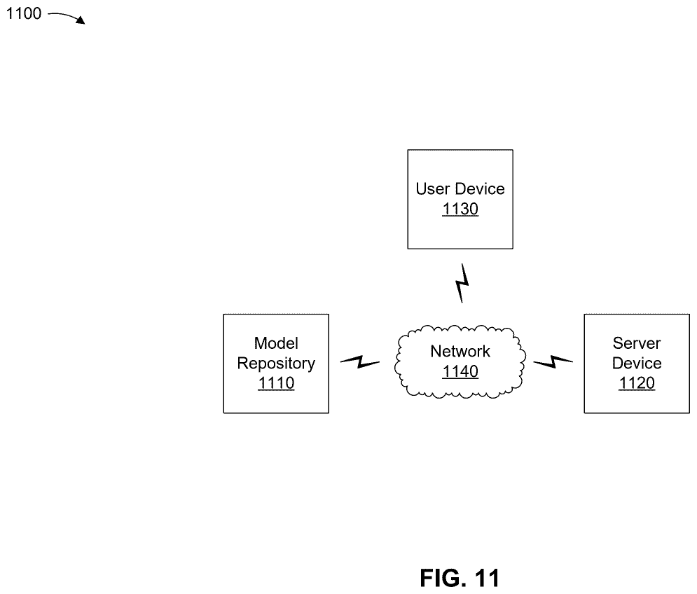

FIG. 4 illustrates an example method 400 for conditional media generation, according to some aspects of the present disclosure. In some examples, the method 400 describes an operation of the material model 1515 described with reference to FIG. 15, such as an application of the guided diffusion model 200 described with reference to FIG. 2. In some examples, the operations shown in FIG. 4 are performed by a system including a processor executing a set of codes to control functional elements of an apparatus, such as the image generation device shown in and described with reference to FIG. 1, or the material mapping device shown in and described with reference to FIG. 8, FIG. 9, FIG. 11, or FIG. 15.

Additionally, or alternatively, one or more steps of the method 400 shown in FIG. 4 may be performed using special-purpose hardware. Generally, the operations are performed according to the methods and processes described in accordance with aspects of the present disclosure. In some cases, the operations described herein include various substeps, or are performed in conjunction with other operations.

At operation 405, a user provides an input prompt (e.g., a text prompt) describing content to be included in a generated media item. For example, a user may provide the prompt “a person playing with a cat”. In some examples, the input prompt can include guidance provided in a form other than text, such as an image, a sketch, or a layout.

At operation 410, the system converts the input prompt (and/or other guidance) into one or more conditional guidance vectors or another multi-dimensional representation. For example, text may be converted into a vector or a series of vectors using a transformer model, or a multi-modal encoder. In some cases, the encoder for the conditional guidance is trained independently of the diffusion model.

At operation 415, the system initializes a noise map that includes random noise. The noise map may be in a pixel space or a latent space. By initializing a media item with random noise, the system can generate different variations of a media item including the content described by the conditional guidance provided in the input prompt.

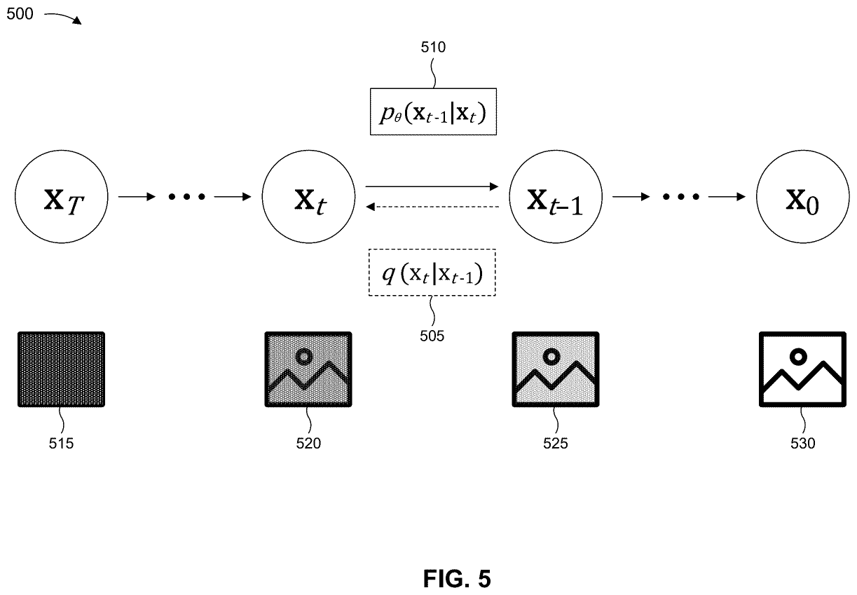

At operation 420, the system generates a media item based on the noise map and the conditional guidance vector(s). For example, the media item may be generated using the reverse diffusion process 225 described with reference to FIG. 4, a reverse diffusion process as described with reference to FIG. 5, or another suitable reverse diffusion process.

As indicated above, FIG. 4 is provided as an example. Other examples may differ from what is described with regard to FIG. 4.

FIG. 5 illustrates an example diffusion process 500, according to some aspects of the present disclosure. In some examples, the diffusion process 500 describes an operation of the material model 1515 described with reference to FIG. 15, such as the reverse diffusion process 225 of the guided diffusion model 200 described with reference to FIG. 1.

As described above with reference to FIG. 2, using a diffusion model can involve both a forward diffusion process 505 for adding noise to a media item (or features in a latent space) and a reverse diffusion process 510 for denoising the media item (or features) to obtain a denoised media item. The forward diffusion process 505 can be represented as q(xₜ|xₜ₋₁), and the reverse diffusion process 510 can be represented as p(xₜ₋₁|xₜ). In some cases, the forward diffusion process 505 is used during training to generate media items with successively greater noise, and a neural network is trained to perform the reverse diffusion process 510 (e.g., to successively remove the noise).

In an example forward diffusion process for a latent diffusion model, the model maps an observed variable x₀(either in a pixel space or a latent space) to intermediate variables x₁, . . . , X_{T} using a Markov chain. The Markov chain gradually adds Gaussian noise to the data to obtain an approximate posterior q(x_{1:T}|x₀) as the latent variables are passed through a neural network such as a U-Net (e.g., U-Net 300), where x₁, . . . , X_{T} have the same dimensionality as x₀.

The neural network may be trained to perform the reverse diffusion process 510. During the reverse diffusion process 510, the model begins with noisy data X_{T}, such as a noisy media item 515, and denoises the data to obtain p(xₜ₋₁|xₜ). At each step t−1, the reverse diffusion process 510 takes xₜ, such as a first intermediate media item 520, and t as inputs, where t represents a step in a sequence of transitions associated with different noise levels. The reverse diffusion process 510 iteratively outputs xₜ₋₁, such as a second intermediate media item 525 from a first intermediate media item 520, until X_{T} reverts back to x₀, where x₀ is the observed variable such as an original media item 530. In some examples, the reverse diffusion process 510 can be represented as:

p_{θ}(xₜ₋₁|xₜ):=N(xₜ₋₁;μ_{θ}(xₜ,t),Σ_{θ}(xₜ,t)) (2)

The joint probability of a sequence of samples in the Markov chain can be written as a product of conditionals and the marginal probability, as follows:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 3 )$$

where p(x_{T})=N(x_{T}; 0, I) is the pure noise distribution as the reverse diffusion process 510 takes the outcome of the forward diffusion process 505 (e.g., a pure noise sample) as an input, and where

$${\prod }_{t = 1}^{T} {p}_{θ} ( {x}_{t - 1} \vert {x}_{t} )$$

represents a sequence of Gaussian transitions corresponding to a sequence adding Gaussian noise to the sample.

In some examples, at interference time, observed data x₀ in a pixel space can be mapped into a latent space as an input, and generated data \tilde{x} is mapped back into the pixel space from the latent space as an output. In some examples, x₀ represents an original input media item with low quality, latent variables x₁, . . . , X_{T} represent noisy media items, and \tilde{x} represents the generated media item with high quality.

As indicated above, FIG. 5 is provided as an example. Other examples may differ from what is described with regard to FIG. 5.

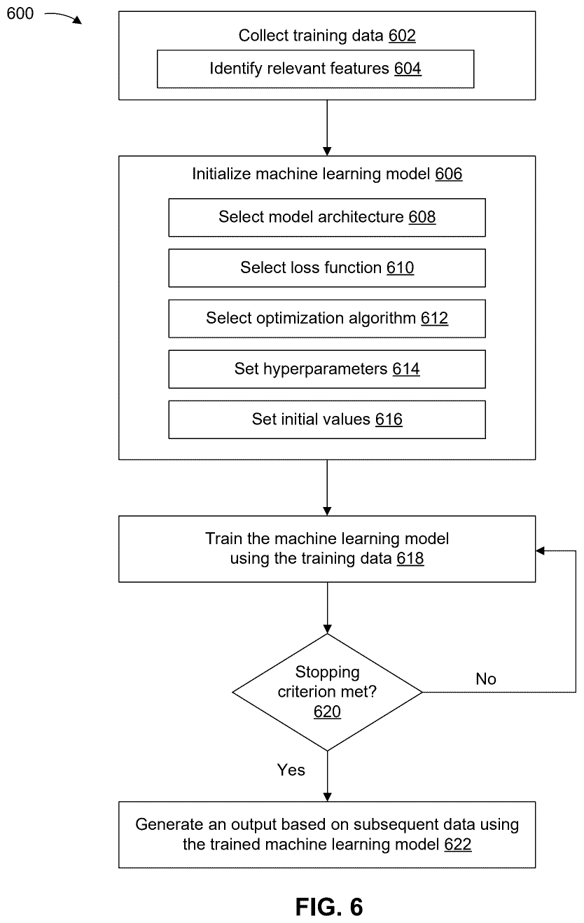

FIG. 6 is a flow diagram illustrating an example procedure 600 for training a machine learning model, according to some aspects of the present disclosure. In some aspects, the procedure 600 describes operation of the training component 1525 for configuring the material model 1515 described with reference to FIG. 15. The procedure 600 provides one or more examples of generating training data, using the training data to train a machine learning model, and using the trained machine learning model to perform a task.

In some examples, a machine learning system collects training data (block 602) that is to be used as a basis to train a machine learning model (e.g., data that defines what is being modeled). The training data is collectable by the machine learning system from various sources. For example, training data sources include public datasets, service provider system platforms that expose application programming interfaces (e.g., social media platforms), and user data collection systems (e.g., digital surveys and online crowdsourcing systems), among other examples. Training data collection may also include data augmentation and synthetic data generation techniques to expand and diversify available training data and/or balancing techniques to balance a number of positive and negative examples, among other examples.

In some aspects, the machine learning system is configurable to identify features that are relevant to a type of task (block 604) for which the machine learning model is to be trained. For example, example machine learning tasks include classification, natural language processing, generative artificial intelligence, recommendation engines, reinforcement learning, and clustering, among other examples. The machine learning system collects the training data based on the identified features and/or filters the training data based on the identified features after collection. The training data is then utilized to train a machine learning model.

In the example procedure 600 illustrated in FIG. 6, in order to train the machine learning model, the machine learning model is first initialized (block 606). Initializing the machine learning model includes selecting a model architecture (block 608) to be trained. Example model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, and deep learning neural networks, among other examples.

As further shown in FIG. 6, initializing the machine learning model includes selecting a loss function (block 610). The loss function is utilized to measure a difference between an output of the machine learning model (e.g., predictions or inferences) and target values (e.g., as expressed by the training data) to be used to train the machine learning model. Additionally, initializing the machine learning model includes selecting an optimization algorithm (block 612) to be used in conjunction with the loss function to optimize parameters of the machine learning model during training. Example optimization algorithms include gradient descent and stochastic gradient descent (SGD), among other examples.

As further shown in FIG. 6, initializing the machine learning model includes setting hyperparameters of the machine learning model (block 614) and setting initial values of the machine learning model (block 616). The hyperparameters are used to control training of the machine learning model, and example hyperparameters include regularization parameters, model parameters (e.g., a number of layers in a neural network), a learning rate, and batch sizes selected from the training data, among other examples. The hyperparameters are set using one or more techniques, such as a randomization technique, or using heuristics learned from other training scenarios, among other examples. Example initial values that are set for the machine learning model include weights and biases of nodes to improve efficiency in training and computational resources consumption as part of training.

As further shown in FIG. 6, the machine learning model is then trained using the training data (block 618) by the machine learning system. A machine learning model is a computer representation that can be tuned (e.g., trained and retrained) based on inputs of the training data to approximate unknown functions. In particular, a machine learning model can include a model that utilizes algorithms (e.g., using the model architectures described above) to learn from, and make predictions on, known data by analyzing training data to learn and relearn to generate outputs that reflect patterns and attributes expressed by the training data.

Example training techniques include supervised learning that employs labeled data, unsupervised learning that involves finding underlying structures or patterns within the training data, reinforcement learning based on optimization functions (e.g., rewards and/or penalties), and use of nodes as part of “deep learning,” among other examples. For example, the machine learning model may be configurable to include a plurality of nodes that collectively form a plurality of layers. The layers, for instance, are configurable to include an input layer, an output layer, and one or more hidden layers. Calculations are performed by the nodes within the layers through hidden states through a system of weighted connections that are “learned” during training (e.g., through use of a selected loss function and backpropagation to optimize performance of the machine learning model to perform an associated task).

As further shown in FIG. 6, training the machine learning model includes determining whether a stopping criterion is met (decision block 620), where the stopping criterion is used to validate the machine learning model. The stopping criterion is usable to reduce overfitting of the machine learning model, to reduce computational resource consumption, and to promote an ability of the machine learning model to address previously unseen data (e.g., data that is not included specifically as an example in the training data). Example stopping criteria include a threshold number of epochs, validation loss stabilization, satisfaction of a performance improvement threshold, achieving a threshold level of accuracy, or satisfaction of performance metrics such as precision and recall, among other examples. As shown in FIG. 6, in cases where the stopping criterion has not been met (“no” from decision block 620), the procedure 600 continues training the machine learning model using the training data (block 618). As shown in FIG. 6, in cases where the stopping criterion has been met (“yes” from decision block 620), the trained machine learning model is then utilized to generate an output based on subsequent data (block 622). For example, the machine learning model is trained to perform a task as described above and, after training, is configured to perform the task based on subsequent data that is received as an input and processed by the machine learning model.

As indicated above, FIG. 6 is provided as an example. Other examples may differ from what is described with regard to FIG. 6.

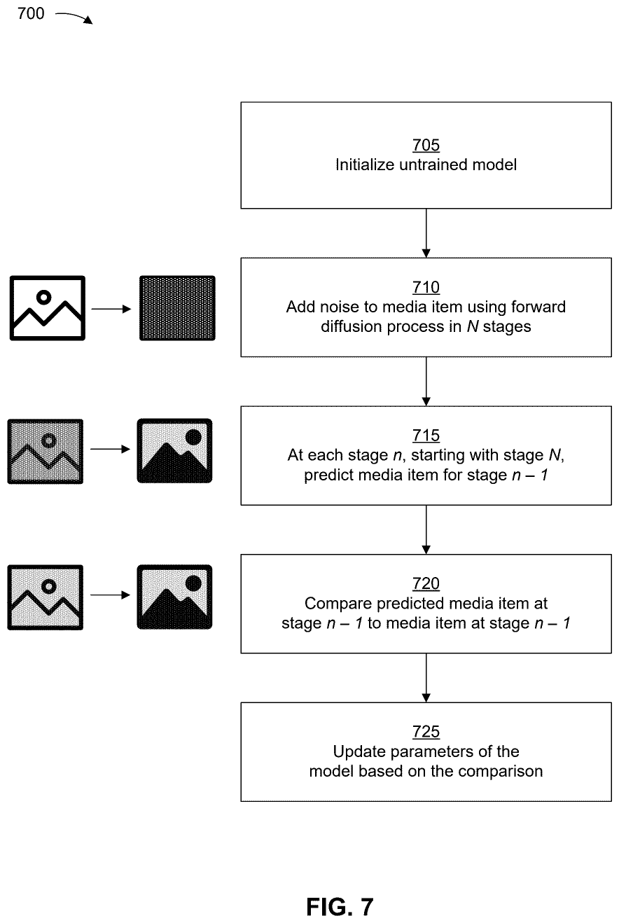

FIG. 7 illustrates an example method 700 for training a diffusion model, according to some aspects of the present disclosure. In some aspects, the method 700 describes operation of the training component 1525 for configuring the material model 1515 described with reference to FIG. 15. The method 700 provides one or more examples of training a reverse diffusion process, as described above with reference to FIG. 2 and/or FIG. 5. In some examples, the operations shown in FIG. 7 are performed by a system including a processor executing a set of codes to control functional elements of an apparatus, such as the image generation device shown in and described with reference to FIG. 1, or the material mapping device shown in and described with reference to FIG. 8, FIG. 9, FIG. 11, or FIG. 15.

Additionally, or alternatively, one or more steps of the method 700 shown in FIG. 7 may be performed using special-purpose hardware. Generally, the operations are performed according to the methods and processes described in accordance with aspects of the present disclosure. In some cases, the operations described herein include various substeps, or are performed in conjunction with other operations.

At operation 705, a user initializes an untrained model. Initializing the untrained model can include defining the architecture of the model and establishing initial values for the parameters associated with the model. In some examples, the initialization can include defining hyperparameters such as the number of layers, the resolution and channels of each layer block, and/or the location of skip connections, among other examples.

At operation 710, the system adds noise to a media item using a forward diffusion process in N stages. In some examples, the forward diffusion process is a fixed process where Gaussian noise is successively added to the media item. In latent diffusion models, the Gaussian noise may be successively added to features in a latent space.

At operation 715, the system performs a reverse diffusion process at each stage n, starting with stage N, to predict the output or features at stage n−1. For example, the reverse diffusion process can predict the noise that was added by the forward diffusion process, and the predicted noise can be removed from the noise input to obtain the predicted output. In some examples, an original media item is predicted at each stage of the training process.

At operation 720, the system compares a predicted output (or features) at stage n−1 to an actual media item (or features), such as the output at stage n−1 or the original input. For example, given observed data x, the diffusion model may be trained to minimize a variational upper bound of a negative log-likelihood−log p_{θ}(x) of the training data.

At operation 725, the system updates parameters of the model based on the comparison of the predicted output at stage n−1 and the output at stage n. For example, the parameters of a U-Net may be updated using gradient descent or other suitable techniques. Time-dependent parameters of the Gaussian transitions can also be learned.

As indicated above, FIG. 7 is provided as an example. Other examples may differ from what is described with regard to FIG. 7.

FIG. 8 illustrates an example 800 associated with training a diffusion model to generate spatially consistent material maps, according to some aspects of the present disclosure. As shown in FIG. 8, example 800 includes a model training system and a model repository. In some aspects, the model training system may be a processing device, such as a server, that can train a diffusion model to generate material images or material maps using an attention mechanism that applies cross-attention, such that a user may execute an application that uses the diffusion model or communicates with the material mapping device to generate a set of material images.

For example, as shown by reference number 810, the material mapping device obtains a foundation diffusion model, also known as a large X model (L×M), from the model repository. For example, the model repository is a public or private data storage device that stores the foundation diffusion model, which has been trained on vast datasets to generate images, video, or other media items from an input prompt that may include text, an image, or other suitable guidance. In some aspects, the diffusion model has a U-Net architecture, such as the U-Net shown and described with reference to FIG. 2, or another suitable architecture, such as a diffusion transformer (DiT) architecture. The diffusion model has an architecture that includes an attention mechanism to determine the relative importance associated with each object in one or more sequences relative to other objects in the one or more sequences. For example, the diffusion model obtained from the model repository may support an attention configuration in which a query vector, a key vector, and a value vector are created for each element in one or more sequences, which include an input prompt. Accordingly, the query, key, and value vectors are used to compute weights for each element in the input prompt, which are used to derive vectors that capture relationships between elements in the input prompt and thereby generate images with attention to different elements in the input prompt. For example, a spatial transformer associated with the diffusion model may use query, key, and value tensors represented as q, k, v∈ [symbol] ^{b×n×h×d}, where b is a batch size, n is a number of spatial pixels in each image, h is a number of attention heads, and d represents feature dimensions.

As shown by reference number 820, the attention mechanism associated with the diffusion model applies cross-attention to generate a group or batch of images, which increases spatial consistency, spatial alignment, or spatial coherence across the images in the batch. For example, the attention mechanism associated with the diffusion model is designed to shape feature maps in a way that groups all of the pixels in a batch of images before attention is applied, ensuring that attention simultaneously spans all images within a batch or channel group. For example, given the set of query, key, value tensors q, k, v∈ [symbol] ^{b×n×h×d} in a spatial transformer, the tensors are shaped to group the images together and then perform attention operations across the group of images (e.g., attention is applied to establish relationships within a sequence corresponding to the input prompt and to one or more sequences that correspond to the pixels in the group of images). For example, in a channel group that includes M images, an attention mechanism that applies self-attention would group the b parameter representing the batch size with the M parameter representing the number of images in the batch, which would result in the M images being generated independently without spatial coherence or consistency.

Accordingly, in some aspects, the attention mechanism of the diffusion model is designed to apply cross-attention when generating a group of images. The attention mechanism of the diffusion model may include a set of transformer attention blocks, and the transformer attention blocks generate a group of images in a way that each pixel in the group of images is generated with attention to every other pixel in the group of images (e.g., in contrast to a self-attention scheme where each pixel in a particular image is generated with attention to every other pixel in that image only). For example, when generating a group of images, the tensors of the transformer attention blocks are shaped to group M images with n spatial pixels, such that all of the spatial pixels in a batch of images are grouped together. The diffusion model may include one or more convolution layers and one or more attention layers, where the convolution layers may generate intermediate features separately for each image in a group of images, and the attention layers apply cross-attention handle the pixels spanning the entire group of images as a single set of pixels.

In this way, the cross-attention design of the attention mechanism provides the diffusion model with capabilities to generate each pixel in the batch with attention to every other pixel in the batch (e.g., the seeds are used to simultaneously generate the various images, with attention applied across the entire set of images, such that different seeds within a channel group output spatially consistent images that preserve feature consistency across all channels, which are optical properties in the case of images that correspond to material maps). As a result, as shown by reference number 830, utilizing the attention mechanism that is designed to apply cross-attention utilizes the text-to-image or image-to-image capabilities of the diffusion model to generate a group of images that are spatially consistent across the various images in the group. Accordingly, the cross-attention design of the attention mechanism provides a high level of spatial consistency across the images in a batch.

As further shown by reference number 840, the model training system may train or fine-tune the diffusion model using a material dataset to produce a high-quality text-to-material or image-to-material diffusion model. For example, in some aspects, the material dataset may include a large library of digital assets that represent various materials and material properties. For example, the material dataset may include digital representations for materials such as different types of wood, metal, fabric, plastic, glass, concrete, bricks, paper, and leather, among other examples, and for other material properties such as patterns, corrosion, cracks, paint, rust, scratches, metal finishes, or the like. For example, reference number 850 depicts example materials that may be modeled in the material dataset (e.g., a sponge, a cactus, a ribbon, and pebbles). In some aspects, the material dataset may model digital materials using a high-resolution, which allows the diffusion model to natively output high-resolution (e.g., 512×512) material maps that can be upsampled to a higher resolution (e.g., 2048×2048). Accordingly, as described herein, the attention mechanism of the diffusion model and the training using the material dataset provide the diffusion model with the capability to generate a group of spatially aligned material maps (e.g., images) that collectively represent a single material and individually represent a single optical property or attribute of the material from the seeds in the same channel group (e.g., a base color, normal map, height, roughness, metallic, and/or opacity, among other examples).

In this way, the diffusion model can be used to generate high-quality groups of images with spatially aligned features to collectively represent a single digital material and individually represent specific optical properties of the digital material. Furthermore, because the diffusion model is built from a foundation model and a large material dataset, the diffusion model incorporates knowledge embedded in text-to-image foundation models that have been trained to generate images using vast datasets and material datasets that model various digital materials, textures, and other visual and tactile details. In addition, the diffusion model is conditioned on text and images using pre-trained embedding networks, which allows the diffusion model to function as a text-to-material model or an image-to-material model.

As indicated above, FIG. 8 is provided as an example. Other examples may differ from what is described with regard to FIG. 8.

FIG. 9 illustrates an example 900 associated with using a diffusion model to generate spatially consistent material maps, according to some aspects of the present disclosure. As shown in FIG. 9, example 900 includes a material mapping device and a user that may interact with the material mapping device. In some aspects, the material mapping device is a processing device, such as a server or a user device, that can use a diffusion model to generate spatially consistent material images (or material maps) associated with a channel group (e.g., a group of optical properties of a material) using cross-attention with respect to the input prompt and the pixels in the generated images. For example, the material mapping device may be a user device that executes an application that uses the diffusion model to generate the material images based on inputs from the user, or the material mapping device may be a server that receives inputs from the user device, uses the diffusion model to generate the material images based on the inputs from the user device, and returns the material images as outputs to the user device.

As shown by reference number 910, the user may provide an input prompt associated with a material to the material mapping device. For example, in some aspects, the input prompt may include a text prompt that describes the material, an image prompt that depicts the material, or another suitable prompt that provides guidance to the material mapping device. In some aspects, as shown by reference number 920, the material mapping device may then generate a set of material maps, corresponding to images of the material indicated in the input prompt, each of which depict a respective optical property of the material. For example, as described herein, the material mapping device may generate a set of seeds based on the input prompt, and may use a diffusion model that has text-to-material or image-to-material inferencing capabilities to generate a set of material maps based on the set of seeds. In addition, as described herein, the diffusion model generates the set of material maps using cross-attention, such that each pixel in the set of material maps is generated with attention to all other pixels in the set of material maps. In this way, the set of material maps includes multiple material channels that are generated simultaneously and coherently, preserving feature consistency across channels.

In addition, as described herein, the diffusion model is trained using a material dataset that embeds information related to various material properties, whereby the diffusion model generates high-resolution material maps (e.g., 512×512 pixels) natively. In addition, the material maps can be upscaled to a desired resolution (e.g., 2048×2048 pixels) to satisfy production requirements. Additionally, the material dataset embeds diverse material properties such that the material maps can depict various surface, reflective, transmissive, emissive, volumetric, or other material properties. For example, the material dataset may represent surfaces or textures, such as ceramic, concrete, asphalt, fabric, ground, leather, marble, metal, organic materials, paint, paper, plaster, plastic, stone, terracotta, translucent, or wood, according to 2D images that can be tiled to conform to the shape of any 3D model. In another example, the material dataset may represent atlases, or special materials that combine small elements, such as debris, flowers, foliage, organic objects, rock or pebbles, or sticks or branches. In another example, the material dataset may represent decals, or materials with built-in masks, that can be used to add distinctive features such as stains, marks, or signage to other textures.

Furthermore, the material dataset embeds various optical properties that can be applied to any suitable material. For example, the optical properties may include a base color that controls a surface tint and affects bounced light and light that refracts through geometry, a glow that controls an intensity of light emitted from the surface, an opacity that controls the visibility of the surface geometry, a roughness that controls how shiny the surface geometry is, and/or a metallic luster of a surface. Other example material properties that may be represented in the material dataset, and therefore modeled in the diffusion model, include interior properties such as a translucence, refractive index, density, or interior color, shape properties such as height or height scale, and/or a normal map that relates to an angle of surface geometry. Accordingly, by designing the attention mechanism of the diffusion model to apply cross-attention, and training the diffusion model with the material dataset, the diffusion model can generate a set of spatially coherent images, with spatially aligned features, for any given input prompt describing or depicting a material.

For example, reference number 930 indicates a set of material maps that the diffusion model generates based on an input prompt including the text “cobblestone with moss” or an input prompt that includes an image of moss growing on cobblestone. In another example, reference number 940 indicates a set of material maps that the diffusion model generates based on an input prompt including the text “fairies blue and pink with flowers” or an input prompt that includes an image of flowers and blue and pink fairies. In another example, reference number 950 indicates a set of material maps that the diffusion model generates based on an input prompt including the text “rubber gloves” or an input prompt that includes an image of rubber gloves. As shown, in each case, the cross-attention design of the attention mechanism results in the set of material maps sharing spatial features, which have the same general shape, size, location, and orientation within each image and collectively depict the material indicated in the input prompt. In addition, the details in the material dataset allow each image (or material map) to depict a respective optical property of the material. For example, in FIG. 9, the set of material maps each depict studio lighting, a base color, a normal map, a height, a roughness, a metallic luster, and an opacity for the same material (although it will be appreciated that the material maps may depict any of the optical properties described above or other suitable optical properties).

As indicated above, FIG. 9 is provided as an example. Other examples may differ from what is described with regard to FIG. 9.

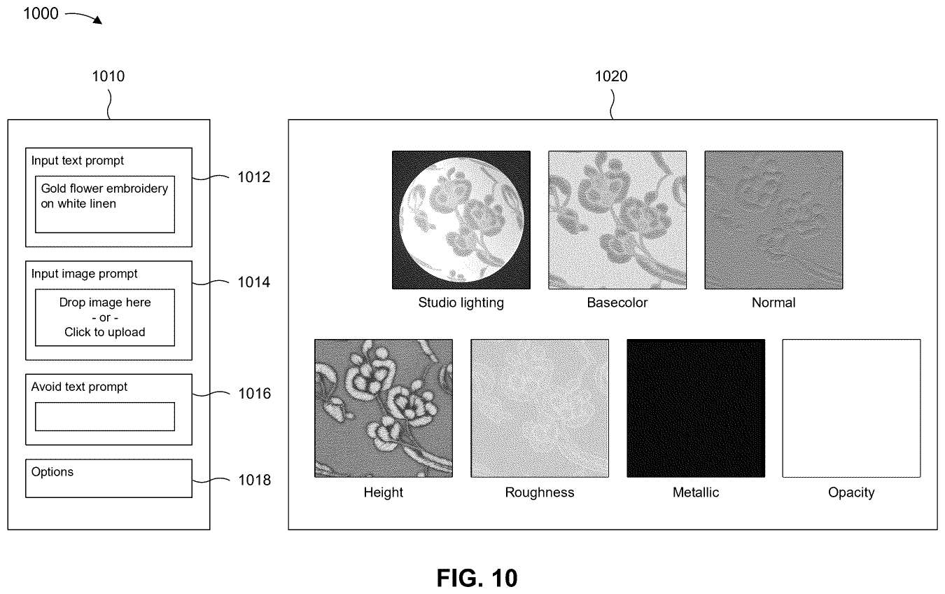

FIG. 10 illustrates an example user interface 1000 associated with using a diffusion model to generate material images using cross-channel attention, according to some aspects of the present disclosure. As described herein, the user interface 1000 is shown on a user device that corresponds to or interacts with a material mapping device that generates a set of spatially coherent material maps (e.g., a set of images that each depict a respective optical property of a material, with shared spatial features aligned across the images) using a diffusion model that uses an attention mechanism that applies cross-attention for text-to-material or image-to-material generation.

For example, as shown in FIG. 10, the user interface 1000 may include an input area 1010 with one or more user interface elements that allow a user to provide guidance for generating a set of material maps. In some aspects, the input area 1010 includes a user interface element 1012 (e.g., a dialog box) that allows the user to input a text prompt that describes a material and a user interface element 1014 (e.g., a drag-and-drop or upload interface) that allows the user to input an image that depicts a material. For example, in FIG. 10, a user has entered the text “Gold flower embroidery on white linen” in the input area 1010 for the text prompt. In addition, as shown, the input area 1010 may include a user interface element 1016 that allows the user to indicate text to be avoided when generating the material maps, and one or more user interface elements 1018 that allow the user to configure certain details related to the material maps. For example, the user interface elements 1018 may allow the user to specify a content type (e.g., photorealistic, illustration, vector graphics), an aesthetic score to control the texture of the material, a sharpness strength that controls the smoothness of the surface, or other suitable options (e.g., to control the translucence, height, metallic luster, or opacity of the material). Additionally, or alternatively, the user interface elements 1018 may provide the user with one or more options to control or otherwise interact with one or more aspects of the cross-attention that the diffusion model applies when generating the material maps. For example, the user interface elements 1018 may provide the user with options to visualize attention weights to focus on how the diffusion model applies attention to different parts of the input prompt or the output images or adjust attention weights to manually or interactively change the outputs from the diffusion model. Additionally, or alternatively, the user interface elements 1018 may provide options for adjusting parameters such as the number of spatial pixels, attention heads, and/or feature dimensions that are used in the spatial transformer, among other examples.

Accordingly, after the user has provided the input prompt and configured any appropriate options, the input prompt and other parameters to guide the material generation may be provided to the diffusion model to generate a set of material maps based on the input prompt (e.g., as described herein with reference to FIG. 1, FIG. 8, and/or FIG. 9). In some aspects, as shown, the user interface 1000 includes an output area 1020 where the set of spatially aligned material maps depicting the material are shown. For example, in FIG. 10, the output area shows a set of images that each depict a white linen material that has gold flower embroidery, with spatially aligned features that are consistent across the entire group of images. In addition, each image depicts a respective optical property of the material, such as a studio lighting map, a base color map, a normal map, a height map, a roughness map, a metallic map, and an opacity map, although any suitable combination of optical properties may be depicted in the material maps.

As indicated above, FIG. 10 is provided as an example. Other examples may differ from what is described with regard to FIG. 10.

FIG. 11 is a diagram illustrating an example environment 1100 associated with a diffusion model for generating spatially consistent material maps, according to some aspects of the present disclosure. As shown in FIG. 11, the environment 1100 may include a model repository 1110, a server device 1120, a user device 1130, and a network 1140. Devices in the environment 1100 may interconnect via wired connections, wireless connections, or a combination thereof.

The model repository 1110 may include one or more devices capable of receiving, generating, storing, processing, and/or providing information associated with a diffusion model for generating spatially consistent material maps, as described elsewhere herein. As an example, the model repository 1110 may store a diffusion model, such as a foundation text-to-image or image-to-image diffusion model, that supports image generation. Additionally, or alternatively, the model repository 1110 may store a text-to-image or image-to-image diffusion model associated with a cross-attention configuration, and/or a diffusion model that has been trained to generate spatially consistent material maps (e.g., groups of images depicting different optical properties of a material) according to a cross-attention configuration. The model repository 1110 may include a communication device and/or a computing device. For example, the model repository 1110 may include a data structure, a database, a data source, a server, a database server, an application server, a client server, a web server, a host server, a proxy server, a virtual server (e.g., executing on computing hardware), a server in a cloud computing system, a device that includes computing hardware used in a cloud computing environment, or a similar type of device.

The server device 1120 may include one or more devices capable of receiving, generating, storing, processing, providing, and/or routing information associated with a diffusion model for generating spatially consistent material maps using cross-attention, as described elsewhere herein. In some aspects, the server device 1120 may correspond or implement features of the model training system shown in FIG. 8, where the server device 1120 may train a diffusion model to generate spatially consistent material maps using cross-attention, as described above with reference to FIG. 8. In some aspects, the server device 1120 may correspond or implement features of the material mapping device shown in FIG. 9, where the server device 1120 may be configured to use a diffusion model to generate material images from an input prompt using cross-attention, as described above with reference to FIG. 9 and/or FIG. 10. The server device 1120 may include a communication device and/or a computing device. For example, the server device 1120 may include an application server, a client server, a web server, a database server, a host server, a proxy server, a virtual server (e.g., executing on computing hardware), or a server in a cloud computing system. In some aspects, the server device 1120 may include computing hardware used in a cloud computing environment, such as one or more serverless components (e.g., one or more serverless functions).

The user device 1130 may include one or more devices capable of receiving, generating, storing, processing, and/or providing information associated with a diffusion model for generating spatially consistent material maps using cross-attention, as described elsewhere herein. In some aspects, the user device 1130 may be configured to use a diffusion model to generate material images from an input prompt using cross-attention, as described above with reference to FIG. 9 and/or FIG. 10, or may be configured to interact with the server device 1120 to provide inputs and receive outputs associated with the diffusion model. For example, the user device 1130 may execute an application that can generate the material images using the diffusion model, may communicate with the server device 1120 to utilize resources of the server device 1120 to generate the material images, or may communicate with the server device 1120 to generate the material images using an application executing on the server device 1120. The user device 1130 may include a communication device and/or a computing device. For example, the user device 1130 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The network 1140 may include one or more wired and/or wireless networks. For example, the network 1140 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 1140 enables communication among the devices of environment 1100.

The number and arrangement of devices and networks shown in FIG. 11 are provided as an example. In practice, there may be additional devices and/or networks, fewer devices and/or networks, different devices and/or networks, or differently arranged devices and/or networks than those shown in FIG. 11. Furthermore, two or more devices shown in FIG. 11 may be implemented within a single device, or a single device shown in FIG. 11 may be implemented as multiple, distributed devices. Additionally, or alternatively, a set of devices (e.g., one or more devices) of environment 1100 may perform one or more functions described as being performed by another set of devices of environment 1100.

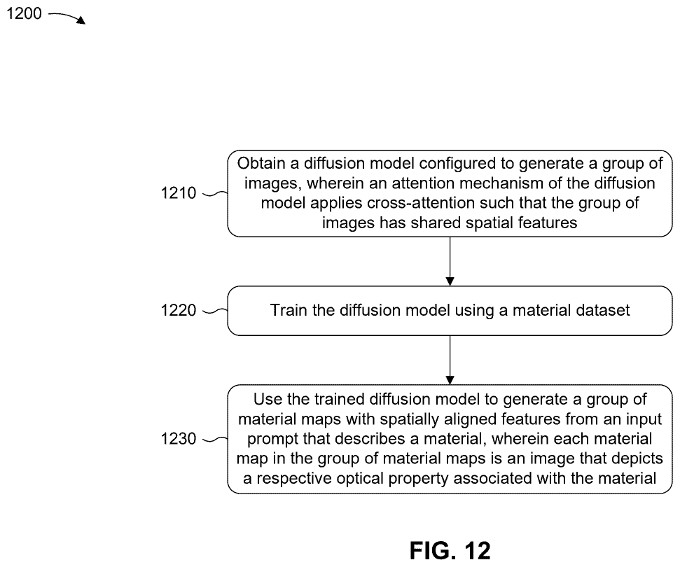

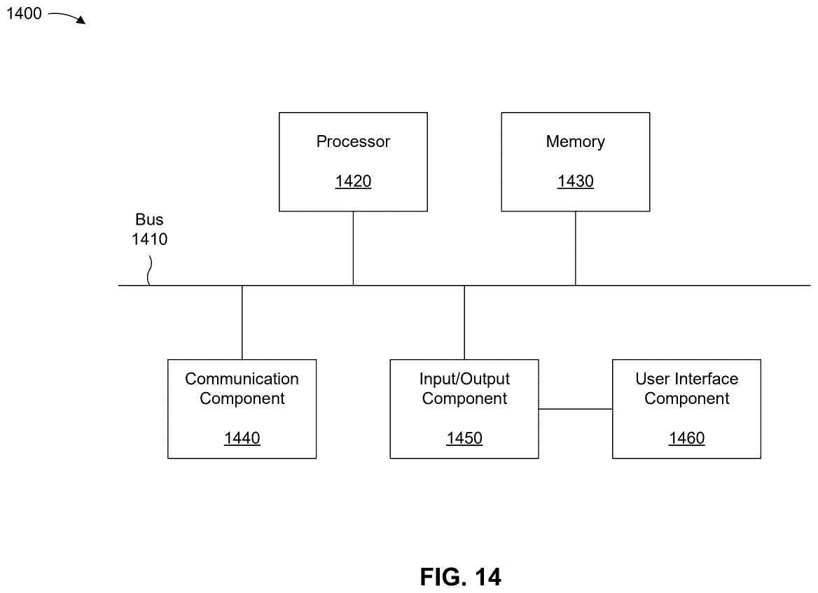

FIG. 12 is a flowchart of an example process 1200 associated with training and using a diffusion model to generate spatially consistent material maps. One or more process blocks of FIG. 12 are performed by a processing device (e.g., server device 1120 and/or user device 1130) and/or by another device or a group of devices separate from or including the processing device. Additionally, or alternatively, one or more process blocks of FIG. 12 may be performed by one or more components of the device 1400 depicted in FIG. 14, such as processor 1420, memory 1430, communication component 1440, I/O component 1450, or user interface component 1460.

As shown in FIG. 12, process 1200 includes obtaining a diffusion model configured to generate a group of images, wherein an attention mechanism of the diffusion model applies cross-attention such that the group of images has shared spatial features (block 1210). For example, the processing device may obtain a diffusion model configured to generate a group of images, wherein an attention mechanism of the diffusion model applies cross-attention such that the group of images has shared spatial features, as described above with respect to reference number 150 in FIG. 1 and/or reference numbers 810-830 in FIG. 8.

As further shown in FIG. 12, process 1200 includes training the diffusion model using a material dataset (block 1220). For example, the processing device may train the diffusion model using a material dataset, as described above with respect to reference number 160 in FIG. 1 and/or reference numbers 840-850 in FIG. 8.

As further shown in FIG. 12, process 1200 includes using the trained diffusion model to generate a group of material maps with spatially aligned features from an input prompt that describes a material, wherein each material map in the group of material maps is an image that depicts a respective optical property associated with the material (block 1230). For example, the processing device may use the trained diffusion model to generate a group of material maps with spatially aligned features from an input prompt that describes a material, wherein each material map in the group of material maps is an image that depicts a respective optical property associated with the material, as described above with respect to reference number 160 in FIG. 1, reference numbers 840-850 in FIG. 8, and/or FIGS. 9-10.

Process 1200 may include additional aspects, such as any single aspect or any combination of aspects described below and/or in connection with one or more other processes described elsewhere herein.

In a first aspect, using the trained diffusion model to generate the group of material maps comprises configuring one or more tensors associated with the diffusion model to group a set of feature maps associated with the group of images and to perform attention operations associated with generating the group of images across the grouped set of features.

In a second aspect, alone or in combination with the first aspect, using the trained diffusion model to generate the group of material maps comprises generating each pixel of a plurality of pixels in the group of images with attention to every other pixel of the plurality of pixels in the group of images.

In a third aspect, alone or in combination with one or more of the first and second aspects, using the trained diffusion model to generate the group of material maps comprises generating a channel group that includes multiple seeds from the input prompt, wherein the channel group includes a plurality of channels that each correspond to a respective optical property associated with the material, inputting the multiple seeds in the channel group to the trained diffusion model, and storing an output from the trained diffusion model, wherein the output comprises the group of material maps with the spatially aligned features.

In a fourth aspect, alone or in combination with one or more of the first through third aspects, the group of material maps have a native resolution based on a resolution of image data associated with the material dataset.

In a fifth aspect, alone or in combination with one or more of the first through fourth aspects, the group of material maps have an upscaled resolution from a resolution of image data associated with the material dataset.

In a sixth aspect, alone or in combination with one or more of the first through fifth aspects, the material dataset comprises a library of material assets that are each associated with a set of parameters representing optical properties of a material.

In a seventh aspect, alone or in combination with one or more of the first through sixth aspects, the input prompt comprises text.

In an eighth aspect, alone or in combination with one or more of the first through seventh aspects, the input prompt comprises an image.

Although FIG. 12 shows example blocks of process 1200, in some implementations, process 1200 includes additional blocks, fewer blocks, different blocks, or differently arranged blocks than those depicted in FIG. 12. Additionally, or alternatively, two or more of the blocks of process 1200 may be performed in parallel.

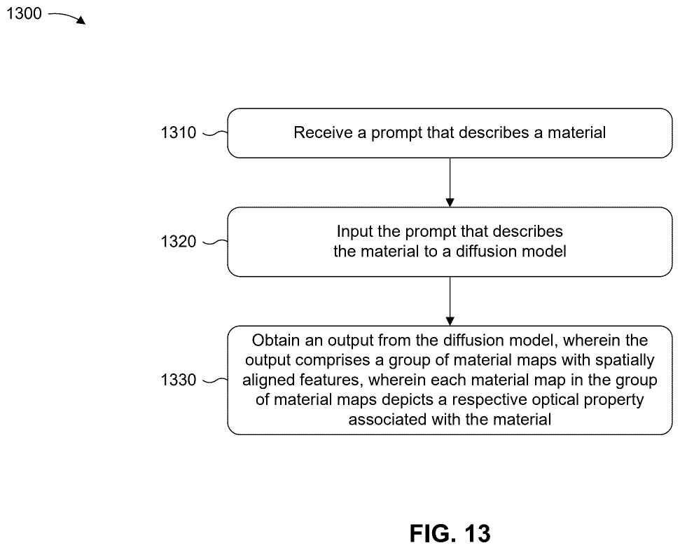

FIG. 13 is a flowchart of an example process 1300 associated with using a diffusion model to generate spatially consistent material maps. One or more process blocks of FIG. 13 are performed by a processing device (e.g., server device 1120 and/or user device 1130) and/or by another device or a group of devices separate from or including the processing device. Additionally, or alternatively, one or more process blocks of FIG. 13 may be performed by one or more components of the device 1400 depicted in FIG. 14, such as processor 1420, memory 1430, communication component 1440, I/O component 1450, or user interface component 1460.

As shown in FIG. 13, process 1300 includes receiving a prompt that describes a material (block 1310). For example, the processing device may receive a prompt that describes a material, as described above.

As further shown in FIG. 13, process 1300 includes inputting the prompt that describes the material to a diffusion model (block 1320). For example, the processing device may input the prompt that describes the material to a diffusion model, as described above.

As further shown in FIG. 13, process 1300 includes obtaining an output from the diffusion model, wherein the output comprises a group of material maps with spatially aligned features, wherein each material map in the group of material maps depicts a respective optical property associated with the material (block 1330). For example, the processing device may obtain an output from the diffusion model, wherein the output comprises a group of material maps with spatially aligned features, wherein each material map in the group of material maps depicts a respective optical property associated with the material, as described above.

Process 1300 may include additional aspects, such as any single aspect or any combination of aspects described below and/or in connection with one or more other processes described elsewhere herein.

In a first aspect, inputting the prompt to the diffusion model comprises generating a channel group that includes multiple seeds from the prompt, wherein the channel group includes a plurality of channels that each correspond to a respective optical property associated with the material, and inputting the multiple seeds in the channel group to the diffusion model.

In a second aspect, alone or in combination with the first aspect, the group of material maps have a native resolution based on a resolution of image data associated with a material dataset.

In a third aspect, alone or in combination with one or more of the first and second aspects, the group of material maps have an upscaled resolution from a resolution of image data associated with a material dataset.

In a fourth aspect, alone or in combination with one or more of the first through third aspects, the prompt comprises a text prompt.

In a fifth aspect, alone or in combination with one or more of the first through fourth aspects, the prompt comprises an image prompt.

Although FIG. 13 shows example blocks of process 1300, in some implementations, process 1300 includes additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example device 1400 associated with a diffusion model for generating material images using cross-attention. In some aspects, the device 1400 corresponds to one or more of the server device 1120 and/or the user device 1130 shown in FIG. 11. In some aspects, the server device 1120 and/or the user device 1130 include one or more devices 1400 and/or one or more components of the device 1400. In the example shown in FIG. 14, the device 1400 includes a bus 1410, a processor 1420, a memory 1430, a communication component 1440, an input/output (I/O) component 1450, and/or a user interface component 1460.

The bus 1410 includes one or more components that enable wired and/or wireless communication among the components of the device 1400. The bus 1410 couples together two or more components of FIG. 14, such as via operative coupling, communicative coupling, electronic coupling, and/or electric coupling. For example, the bus 1410 may include an electrical connection (e.g., a wire, a trace, and/or a lead) and/or a wireless bus. The processor 1420 includes a central processing unit, a graphics processing unit, a microprocessor, a controller, a microcontroller, a digital signal processor, a field-programmable gate array, an application-specific integrated circuit, and/or another type of processing component. The processor 1420 may be implemented in hardware, firmware, or a combination of hardware and software. In some aspects, the processor 1420 includes one or more processors capable of being programmed to perform one or more operations or processes described elsewhere herein.

The memory 1430 includes volatile and/or nonvolatile memory, such as random access memory (RAM), read only memory (ROM), a hard disk drive, and/or another type of memory (e.g., a flash memory, a magnetic memory, and/or an optical memory). The memory 1430 may include internal memory (e.g., RAM, ROM, or a hard disk drive) and/or removable memory (e.g., removable via a universal serial bus connection). In some aspects, the memory 1430 is a non-transitory computer-readable medium. The memory 1430 stores information, one or more instructions, and/or software (e.g., one or more software applications) related to the operation of the device 1400. In some aspects, the memory 1430 includes one or more memories that are coupled (e.g., communicatively coupled) to one or more processors (e.g., processor 1420), such as via the bus 1410. Communicative coupling between a processor 1420 and a memory 1430 enables the processor 1420 to read and/or process information stored in the memory 1430 and/or to store information in the memory 1430.

The communication component 1440 enables the device 1400 to communicate with other devices via a wired connection and/or a wireless connection. For example, the communication component 1440 may include a receiver, a transmitter, a transceiver, a modem, a network interface card, and/or an antenna.

The I/O component 1450 enables the device 1400 to receive input, such as user input and/or sensed input. For example, the I/O component 1450 may include a touch screen, a keyboard, a keypad, a mouse, a button, a microphone, a switch, a sensor, a global positioning system sensor, a global navigation satellite system sensor, an accelerometer, a gyroscope, and/or an actuator. Additionally, or alternatively, the I/O component 1450 enables the device 1400 to provide output, such as via a display, a speaker, and/or a light-emitting diode. In some aspects, the I/O component 1450 is controlled by an I/O controller to manage input and output signals for the device 1400. In some cases, the I/O component 1450 manages peripherals not integrated into the device 1400. In some cases, the I/O component 1450 represents a physical connection or port to an external peripheral. In some cases, the I/O controller represents or interacts with a modem, a keyboard, a mouse, a touchscreen, or a similar device. In some cases, the I/O controller is implemented as a component of a processor. In some cases, a user interacts with the device 1400 via the I/O component 1450 or via one or more hardware components controlled by the I/O controller.

The user interface component 1460 enables a user to interact with the device 1400 (e.g., via the I/O component 1450). In some cases, the user interface component 1460 includes an audio device, such as an external speaker system, an external display device such as a display screen, an input device (e.g., a remote-control device interfaced with a user interface directly or through the I/O controller), or a combination thereof. In some cases, the user interface component 1460 includes a graphical user interface.

In some aspects, the device 1400 performs one or more operations or processes described herein. For example, a non-transitory computer-readable medium (e.g., memory 1430) may store a set of instructions (e.g., one or more instructions or code) for execution by the processor 1420. The processor 1420 may execute the set of instructions to perform one or more operations or processes described herein. In some aspects, execution of the set of instructions, by one or more processors 1420, causes the one or more processors 1420 and/or the device 1400 to perform one or more operations or processes described herein. In some aspects, hardwired circuitry is used instead of or in combination with the instructions to perform one or more operations or processes described herein. Additionally, or alternatively, the processor 1420 may be configured to perform one or more operations or processes described herein. Thus, aspects described herein are not limited to any specific combination of hardware circuitry and software.

The number and arrangement of components shown in FIG. 14 are provided as an example. The device 1400 may include additional components, fewer components, different components, or differently arranged components than those shown in FIG. 14. Additionally, or alternatively, one or more components of the device 1400 may perform one or more functions described as being performed by another set of components of the device 1400.

FIG. 15 is a diagram illustrating an example material mapping apparatus 1500 configured to train and/or use a diffusion model to generate spatially consistent material maps, according to some aspects of the present disclosure. In some aspects, the material mapping apparatus 1500 includes or implements aspects associated with the image generation device shown and described with reference to FIG. 1, the guided diffusion model shown and described with reference to FIG. 2, the U-Net shown and described with reference to FIG. 3, the material mapping device shown and described with reference to FIGS. 8-11, the user device shown and described with reference to FIG. 11, and/or the device 1400 or one or more components of the device 1400 shown and described with reference to FIG. 14. As shown in FIG. 15, the material mapping apparatus 1500 includes a processor unit 1505, a memory unit 1510, an I/O component 1520, and a training component 1525. The training component 1525 updates parameters of a material model 1515 stored in the memory unit 1510. In some examples, the training component 1525 is located outside the material mapping apparatus 1500.

The processor unit 1505 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof. In some cases, the processor unit 1505 is configured to operate a memory array using a memory controller. In other cases, a memory controller is integrated into the processor unit 1505. In some cases, the processor unit 1505 is configured to execute computer-readable instructions stored in the memory unit 1510 to perform various functions. In some aspects, the processor unit 1505 includes special purpose components for modem processing, baseband processing, digital signal processing, or transmission processing. According to some aspects, the processor unit 1505 comprises one or more processors 1420 described with reference to FIG. 14.

The memory unit 1510 includes one or more memory devices. Examples of a memory device include random access memory (RAM), read-only memory (ROM), or a hard disk.

Examples of memory devices include solid state memory and a hard disk drive. In some examples, memory is used to store computer-readable, computer-executable software including instructions that, when executed, cause at least one processor of the processor unit 1505 to perform various functions described herein.

In some cases, the memory unit 1510 includes a basic input/output system (BIOS) that controls basic hardware or software operations, such as an interaction with peripheral components or devices. In some cases, the memory unit 1510 includes a memory controller that operates memory cells of the memory unit 1510. For example, the memory controller may include a row decoder, column decoder, or both. In some cases, the memory cells within the memory unit 1510 store information in the form of a logical state. According to some aspects, the memory unit 1510 is an example of the memory 1430 described with reference to FIG. 14.

According to some aspects, the material mapping apparatus 1500 uses one or more processors of the processor unit 1505 to execute instructions stored in the memory unit 1510 to perform functions described herein. For example, the material mapping apparatus 1500 may configure and/or use the material model 1515 to generate a group of images with spatially aligned features to depict respective optical properties of a digital material based on an input prompt.

The I/O component 1520 receives inputs from and transmits outputs of the material mapping apparatus 1500 to other devices or users. For example, the I/O component 1520 receives inputs corresponding to one or more input prompts describing or depicting a material and transmits outputs corresponding to one or more images that depict respective optical properties of the material. According to some aspects, the I/O component 1520 is an example of the I/O component 1450 described with reference to FIG. 14.

In some aspects, as described herein, the material mapping apparatus 1500 obtains a diffusion model configured to generate a group of images, wherein an attention mechanism of the diffusion model applies cross-attention such that the group of images has shared spatial features; trains the diffusion model using a material dataset; and uses the trained diffusion model as the material model 1515 to generate a group of material maps with spatially aligned features from an input prompt that describes a material, wherein each material map in the group of material maps is an image that depicts a respective optical property associated with the material.

Additionally, or alternatively, the material mapping apparatus 1500 receives a prompt that describes a material; inputs the prompt that describes the material to the material model 1515; and obtains an output from the material model 1515, wherein the output comprises a group of material maps with spatially aligned features, wherein each material map in the group of material maps depicts a respective optical property associated with the material.

In some embodiments, the material model 1515 is an artificial neural network (ANN) such as the guided diffusion model described with reference to FIG. 2 and the U-Net described with reference to FIG. 3. An ANN can be a hardware component or a software component that includes connected nodes (e.g., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the material model 1515 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

The training component 1525 may train the material model 1515. For example, parameters of the material model 1515 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 6 and FIG. 7). The goal of the training process may be to find optimal values for the parameters that allow the machine learning model to make accurate predictions or perform well on the given task.

Accordingly, the node weights can be adjusted to improve the accuracy of the output (e.g., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the material model 1515 can be used to make predictions on new, unseen data (e.g., during inference).

The number and arrangement of components shown in FIG. 15 are provided as an example. The material mapping apparatus 1500 may include additional components, fewer components, different components, or differently arranged components than those shown in FIG. 15. Additionally, or alternatively, one or more components of the material mapping apparatus 1500 may perform one or more functions described as being performed by another set of components of the material mapping apparatus 1500.

The foregoing disclosure provides illustration and description, but is not intended to be exhaustive or to limit the aspects to the precise forms disclosed. Modifications may be made in light of the above disclosure or may be acquired from practice of the disclosed aspects.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects described herein. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
obtaining a diffusion model configured to generate a group of images, wherein an attention mechanism of the diffusion model applies cross-attention such that the group of images has shared spatial features;
training the diffusion model using a material dataset; and
using the trained diffusion model to generate a group of material maps with spatially aligned features from an input prompt that describes a material, wherein each material map in the group of material maps is an image that depicts a respective optical property associated with the material.

2. The method of claim 1, wherein using the trained diffusion model to generate the group of material maps comprises:
configuring one or more tensors associated with the diffusion model to group a set of feature maps associated with the group of images and to perform attention operations associated with generating the group of images across the grouped set of features.

3. The method of claim 1, wherein using the trained diffusion model to generate the group of material maps comprises:
generating each pixel of a plurality of pixels in the group of images with attention to every other pixel of the plurality of pixels in the group of images.

4. The method of claim 1, wherein using the trained diffusion model to generate the group of material maps comprises:
generating a channel group that includes multiple seeds from the input prompt, wherein the channel group includes a plurality of channels that each correspond to a respective optical property associated with the material;
inputting the multiple seeds in the channel group to the trained diffusion model; and
storing an output from the trained diffusion model, wherein the output comprises the group of material maps with the spatially aligned features.

5. The method of claim 1, wherein the group of material maps have a native resolution based on a resolution of image data associated with the material dataset.

6. The method of claim 1, wherein the group of material maps have an upscaled resolution from a resolution of image data associated with the material dataset.

7. The method of claim 1, wherein the material dataset comprises a library of material assets that are each associated with a set of parameters representing optical properties of a material.

8. The method of claim 1, wherein the input prompt comprises text.

9. The method of claim 1, wherein the input prompt comprises an image.

10. A system, comprising:
a memory component; and
a processing device coupled to the memory component, the processing device to:
obtain a model configured to generate a group of images with shared spatial features;
train the model using a material dataset; and
use the trained model to generate a group of material maps with spatially aligned features from an input prompt that describes a material, wherein each material map in the group of material maps is an image that depicts a respective optical property associated with the material.

11. The system of claim 10, wherein the processing device, to use the trained model to generate the group of material maps, is configured to:
shape one or more tensors associated with the model to group a set of feature maps associated with the group of images and to perform attention operations associated with generating the group of images across the grouped set of features.

12. The system of claim 10, wherein the processing device, to use the trained model to generate the group of material maps, is configured to:
generate each pixel of a plurality of pixels in the group of images with attention to every other pixel of the plurality of pixels in the group of images.

13. The system of claim 10, wherein the processing device, to use the trained model to generate the group of material maps, is configured to:
generate a channel group that includes multiple seeds from the input prompt, wherein the channel group includes a plurality of channels that each correspond to a respective optical property associated with the material;
input the multiple seeds in the channel group to the trained model; and
store an output from the trained model, wherein the output comprises the group of material maps with spatially aligned features.

14. The system of claim 10, wherein the material dataset comprises a library of material assets that are each associated with a set of parameters representing optical properties of a material.

15. A method, comprising:
receiving a prompt that describes a material;
inputting the prompt that describes the material to a diffusion model; and
obtaining an output from the diffusion model, wherein the output comprises a group of material maps with spatially aligned features, wherein each material map in the group of material maps depicts a respective optical property associated with the material.

16. The method of claim 15, wherein inputting the prompt to the diffusion model comprises:
generating a channel group that includes multiple seeds from the prompt, wherein the channel group includes a plurality of channels that each correspond to a respective optical property associated with the material; and
inputting the multiple seeds in the channel group to the diffusion model.

17. The method of claim 15, wherein the group of material maps have a native resolution based on a resolution of image data associated with a material dataset.

18. The method of claim 15, wherein the group of material maps have an upscaled resolution from a resolution of image data associated with a material dataset.

19. The method of claim 15, wherein the prompt comprises a text prompt.

20. The method of claim 15, wherein the prompt comprises an image prompt.
